(19) United States
(12) Patent Application Publication
(10) Pub. No.: US 2025/0107540 A1
(43) Pub. Date: Apr. 3, 2025

(54) METHOD FOR CREATING MALASADAS AND OTHER FOOD PRODUCTS

(71) Applicant: Jason Losagio, Nazareth, PA (US)

(72) Inventor: Jason Losagio, Nazareth, PA (US)

(21) Appl. No.: 18/375,816

(22) Filed: Oct. 2, 2023

(51) Int. Cl. A21D 13/60; A21D 2/18; A21D 2/34; A21D 2/36; A21D 8/04; A21D 13/28; A21D 13/38

(52) U.S. Cl. CPC A21D 13/60; A21D 2/181; A21D 2/34; A21D 2/36; A21D 8/047; A21D 13/28; A21D 13/38

(57) ABSTRACT

A process for making bulk food products. The process involves providing mixed bags of ingredients. The mixed bags of ingredients provide the components needed to create malasadas. The resulting malasadas are consistent and efficiently prepared. Additionally, ingredients can be shipped and stored easily.

### BACKGROUND

### 1. Field

This application is directed towards a process of making dough-based food items. In particular, the application is directed towards a process of making dough-based products using a dry ingredient mixture.

### 2. Description of the Related Art

Malasadas are a Portuguese confection that has become a beloved treat in many cultures, particularly in Hawaii and Portugal. The traditional process of making malasadas results in soft, pillowy fried doughnuts with a delicate crispy exterior. The process typically involves a few key steps: creating a yeast-based dough, allowing it to rise, shaping the dough into rounds, frying until golden brown, and dusting with powdered sugar.

The process begins with the yeast-based dough, prepared by combining warm milk, sugar, yeast, and a small amount of flour. This mixture is allowed to rest and develop for around 15-20 minutes, during which time the yeast activates, and the mixture becomes frothy. The frothy mixture is then combined with more flour, eggs, butter, and a pinch of salt. This dough is kneaded until smooth and elastic, then left to rise for several hours until it doubles in size. Once risen, the dough is gently deflated and divided into rounds, which are shaped by hand.

Creating malasadas in the manner described above is inconvenient and results in inconsistency. Furthermore, creating malasadas in the manner described above is inefficient since it involves multiple steps of mixing wet and dry ingredients.

Therefore, there is a need to provide a streamlined process for creating a uniform and consistent malasada.

### SUMMARY

Briefly described, aspects of the present disclosure are directed to a method for making malasadas.

An aspect of the disclosure is a method for making malasadas. The method comprising mixing a plurality of components to form a mixture, the mixture comprising; mixing a plurality of components to form a mixture, the mixture comprising: bread flour, milk powder, cane sugar, whole egg powder, butter powder, dough improver, egg yolk powder, nutmeg powder, lemon peel powder, vanilla extract powder, and salt; placing the mixture into a mixer with an instant yeast and mixing the mixture and the instant yeast; adding water to the mixture and instant yeast to form dough; creating dough balls with the dough; frying the dough balls in canola oil; coating the fried dough balls with sugar, and filling the fried dough ball with a filling.

Another aspect of the disclosure is a method for making malasadas. The method comprising mixing a plurality of components to form a mixture, the mixture comprising; bread flour, whole milk powder, cane sugar, whole egg powder, butter powder, dough improver, egg yolk powder, nutmeg powder, lemon peel powder, vanilla extract powder, and salt; placing the mixture into a container with a packet of instant yeast; placing the mixture into a mixer with the instant yeast and mixing the mixture and the instant yeast; adding water to the mixture and instant yeast to form dough; creating dough balls with the dough; frying the dough balls; coating the fried dough balls with sugar or cinnamon and sugar; and filling the fried dough ball with a filling.

### BRIEF DESCRIPTION OF THE DRAWINGS

FIG. 1 shows a flow chart of a method of making malasadas.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described treatments or methods and may be utilized in other treatments and methods as will be understood by those skilled in the art familiar with this disclosure.

The components described hereinafter as making up the various embodiments are intended to be illustrative and not restrictive. Many suitable components that would perform the same or a similar function as the components described herein are intended to be embraced within the scope of embodiments of the present disclosure.

Creating malasadas using an all-dry ingredient mix offers several advantages, both in terms of convenience and consistency. Such a mix pre-incorporates the dry ingredients, such as flour, sugar, yeast, and salt, in precise proportions. This eliminates the need for bakers to measure and mix these ingredients individually, reducing the potential for errors and inconsistencies in the final product.

Additionally, an all-dry mix significantly streamlines the malasada-making process. Traditional methods involve multiple steps of mixing wet and dry ingredients, waiting for yeast activation, and allowing the dough to rise. With a pre-mixed dry ingredient blend, the initial stages of dough preparation are simplified as adding the appropriate liquid components to the mix. This saves time and effort, making malasada preparation quicker and consistent.

Furthermore, using a pre-mixed dry ingredient blend leads to greater consistency in the final product. Precise measurements and uniform distribution of ingredients are important factors in achieving the desired texture, flavor, and appearance of malasadas. A standardized dry mix ensures that regardless of experience level, malasadas are produced that closely matches the traditional characteristics of the treat. This consistency contributes to the preservation of malasadas' authentic taste and quality across different kitchens and regions.

In the process of creating the malasadas, an important step is formation of a mixture. The mixture is created by taking a plurality of the ingredients and placing them into a powdered form. The mixture is formed by taking bread flour, butter powder, whole egg powder, egg yolk powder, cane sugar, whole milk powder, dough improver, nutmeg powder, lemon peel powder, salt, and vanilla powder and mixing them together.

Such ingredients, after being blended, will form the mixture and will be put in 30-pound (453.6 grams) sealed bags. Inside the bag, but not in the actual mixture, will be a small bag which contains the appropriate amount of instant yeast for the dry mixture.

When creating a batch of malasadas, the 30 lb bag of dry mix is opened. Next, the packet of instant yeast is removed and set aside.

The bag mixture is emptied into the 40 qt (37.85 Liter) mixer. Right after placing the mixture into the mixer, instant yeast will be put into the mixer. On a low operating setting, to the mixture will mix for 2 minutes to incorporate the instant yeast evenly. Next, with the mixer still in the low-speed operating setting, 25% of the warm water will be poured into the 40 qt mixer, after 10 seconds, another 25% of water will be poured into the mixer. After another 10 seconds another 25% or water will be poured into the mixture. After another 10 seconds, the last 25% of water will be added into the mixture.

The mixture is mixed on low setting for 14 minutes. It should be understood that more or less time than 14 minutes may be used in mixing the mixture, however 14 minutes generally provides good results. After 14 minutes, dough scraper is used to scrape down the sides of the bowl and the spiral hook to make sure there is no dough left over.

The dough is left to rest for 6 minutes in the mixing bowl. After it rests, the dough is transferred into two plastic dough tubs and moved to a worktable. Also at the worktable, 5 plastic dough containers are obtained and four of the plastic dough containers their interiors are coated with 12 grams of canola oil. In the 5^{th} dough container, the interior is coated with 5.3 grams of canola oil.

The two plastic dough containers filled with dough are cut and weighed into four, 69 oz (1.926 kg) pieces of dough and two pieces are placed inside of each of the four oiled plastic dough containers. The remaining 30.5 oz (0.865 kg) of dough is placed in the last dough container that has 5.3 grams of canola oil in it.

The dough pieces are gently kneaded and massaged for 5 minutes each for the first four containers that have 69 oz pieces, and 2.5 minutes for the fifth container that holds the 30.5 oz piece.

Each cut piece of dough is formed in the containers into large rectangular shapes to fit into the plastic dough containers. This is a total of 8 rectangular shapes, 7 of the 69 oz dough and 1 of the 30.60z dough. As each is shaped, each dough piece is coated with the oil and worked into the dough.

The mixture is formed using the components proportioned with respect to each other. The total amount of the mixture formed may be increased or decreased by proportionally increasing or decreasing the components. The percentage of the respective components forming the mixture will remain substantially the same with respect to the entire composition. An example is provided below. The example provided below is used to form a mixture and an associated package of instant yeast that is in total 13,607 grams.

The mixture, without the instant yeast totals 13,459 grams and comprises the following: 9,944 grams of bread flour, 889 grams of whole milk powder, 785 grams of cane sugar, 680 grams of whole egg powder, 523 grams of butter powder, 235 grams of dough improver, 209 grams of egg yolk powder, 52 grams of nutmeg powder, 52 grams of lemon peel powder, 52 grams of vanilla powder, and 26 grams of salt. This mixture is formed and later combined with 157 grams of instant yeast. This mixture is formed and later combined with 253.8 fluid ounces of water. After the mix is completed, the dough is kneaded and folded, 52 grams of canola oil are incorporated into the dough.

Vegan malasadas may also be formed using the appropriate ingredients. Additionally, a separate fryer can be implemented when forming vegan malasadas.

The mixture comprises, approximately, in terms of percentages by weight, 48% bread flour, 36% water, 4.0% milk powder, 4.0% cane sugar, 3.3% whole egg powder, 2.5% butter powder, 1.1% dough improver powder, 1.0% egg yolk powder, 0.007% instant yeast, 0.002% nutmeg powder, 0.002% lemon peel powder, 0.002% vanilla extract powder, 0.002% canola oil, and 0.085% salt.

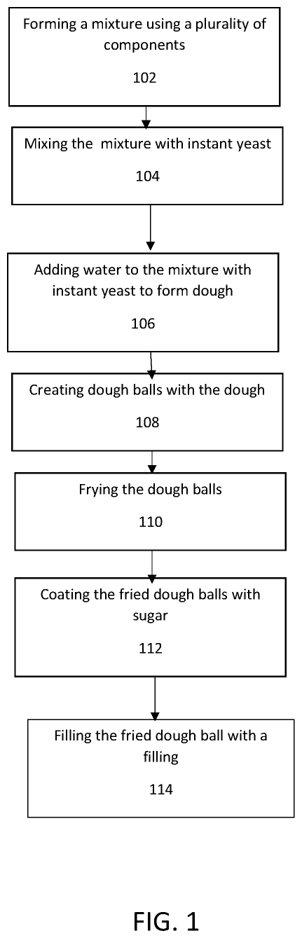

Reference is now made to FIG. 1, wherein an embodiment of the method for creating the malasadas is set forth. In step 102, the components of the mixture are mixed to form the mixture. This mixture process takes the components of the malasadas, including those components that are typically mixed differently, such as butter, eggs, and milk and combine them into a uniform mixture, such as set forth above.

The uniform mixture can be stored and shipped with ease. The uniform mixture can be used to form malasadas in a uniform manner. The mixture is placed in a container with a packet of 157 g of instant yeast. In an embodiment, the container is a sack. In an embodiment, the container is a plastic container. In an embodiment, the container is a plastic sack.

Once the container arrives at its predetermined location the instant yeast package is removed from the container. The mixture is placed within a 40-quart mixer. If the mixture contains more or fewer ingredients than those which are discussed above, the size of the of the mixer may vary. The instant yeast from the packet within the container is added to the mixer.

In step 104 the mixture is mixed with the instant yeast. The mixer is turned on a low setting and the mixer mixes the mixture with the instant yeast for 2 minutes. In an embodiment, the mixer mixes the mixture with the instant yeast for less 2 minutes. In an embodiment the mixer mixes the mixture with the instant yeast for more than 2 minutes. In an embodiment, the mixer mixes the mixture with the instant yeast for less than 2 minutes.

In step 106, water is added to the mixture with instant yeast to form dough. Next, with the mixer still in the low-speed operating setting, one will begin to pour warm 25% of the warm water into the 40 qt mixer, wait 10 seconds, add another 25% of water, wait 10 seconds, add another 25% or water, wait 10 seconds, and then add the last 25% of water. Continue to mix on low setting for 14 minutes.

In step 108 dough balls are created with the dough. The dough is removed from the mixer and placed onto a working table.

After 14 minutes of mixing with water, a dough scraper is used to scrape down the sides of the bowl and spiral hook to make sure there is no dough left over. The dough then rests for 6 minutes in the mixing bowl. After it rests, all the dough is transferred into three plastic dough tubs and moved to the worktable. At the worktable are 6 plastic dough containers. Five of them are coated with 9.7 grams of canola oil. In the 6th container, the interior is coated with 4.5 grams of canola oil.

Using the three plastic dough containers where all the dough was put in from the 40-quart mixer, ten, 69 oz pieces of dough are cut and weighed and two pieces are placed inside of each of the five oiled plastic dough containers. The remaining 45.6 oz of dough in the last dough container has 5.0 grams of canola oil in it. The dough pieces are gently kneaded and massaged for 5 minutes each for the first five containers that have two 69 oz pieces, and 2.5 minutes for the sixth container that holds the 45.6 oz piece.

Each cut piece of dough in the containers is formed into large rectangular shapes to fit into the plastic dough containers. This is a total of 11 rectangular shapes, 10 of the 69 oz dough and 1 of the 45.6 oz. dough. As shaped, each dough piece is coated with the oil and worked into the dough. The plastic dough containers are placed with dough inside a proofer to rise for 1 hour.

The plastic dough containers are taken out of the proofer and brought to the worktable. With the dough still inside of the plastic dough containers, the dough is gently pressed to release air. The dough is gently and kneaded for 3.5 minutes for the first five containers that hold two, 69 oz pieces, and for 1.5 minutes for the fifth container hold the 45.6 oz piece. Each piece of dough in the containers is formed into large rectangle shapes as previously done. The 6 plastic dough containers are placed back into the proofer to rise for another 30 minutes.

Still referring to step 108 and the formation of dough balls. 6 dough ball and divider trays are placed on the worktable. The first 10, 69 oz dough pieces are taken and placed each on the dough ball and divider trays.

The dough is gently pushed so it is centered, circled shaped, and covers about 60% of the tray's surface. The 11^{th} dough piece (the 45.6 oz one) is placed on the tray and the same forming activities are achieved.

The trays are put, one at a time, into the dough roller and baller machine and cut and shaped into 2.4 oz malasada dough balls. All shaped dough balls are moved onto the trays and brought to the worktable. In an embodiment, shapes other than dough balls are formed. In an embodiment, dough cubes are formed. In an embodiment, irregular shaped dough packets are formed.

In step 110 the dough balls are fried. Proofing frying screens are placed on worktable. The formed malasada dough shapes are transferred onto the proofing frying screens 2 inches apart from each other. This is continued until all malasada dough shapes are on the proofer frying screens.

The proofer frying screens are placed into the proofer for 45 minutes. The proofer frying screens are taken out of the proofer and slid into standing holding racks. The malasada dough balls rest for 5 minutes.

After resting, the malasada dough balls are transferred over to the fryer and fried. After the malasadas are fried, they are lifted up and out of the fryer and allowed to sit for 30 seconds so excess grease can drip down and cool them a bit. The malasadas from the frying rack are transferred and placed inside a heat lamp malasada station.

In step 112 the fried dough balls are coated with sugar. In an embodiment, the fried dough balls are coated with sugar and cinnamon. Optionally, the malasadas can be filled with fillings.

In step 114 the fried dough ball is filled with filling. In an embodiment, the fried dough balls are filled with custard. In an embodiment, the fried dough balls are filled with fruit fillings. In an embodiment, the fried dough balls are filled with chocolate cream. In an embodiment, the fried dough balls are filled with holland cream, Bavarian cream, jelly, strawberry cream, Ube cream, and/or mango cream.

Finished malasadas (coated/filled) are transferred over to the employee boxing station where employees will take specific types of malasadas the customer ordered and box them up. While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method for making malasadas comprising:
mixing a plurality of components to form a mixture, the mixture comprising; bread flour, milk powder, cane sugar, whole egg powder, butter powder, dough improver, egg yolk powder, nutmeg powder, lemon peel powder, vanilla extract powder, and salt;
placing the mixture into a mixer with an instant yeast and mixing the mixture and the instant yeast;
adding water to the mixture and instant yeast to form dough;
creating dough balls with the dough;
frying the dough balls in canola oil;
coating the fried dough balls with sugar, and
filling the fried dough ball with a filling.

2. The method of claim 1, wherein the step of coating further comprises coating the fried dough ball with cinnamon.

3. The method of claim 1, wherein the mixture weighs greater than 17 kilograms.

4. The method of claim 3, further comprising placing the dough into dough tubs and then into a proofer for an hour prior to creating the dough balls.

5. The method of claim 4, wherein the step of creating the dough balls comprises placing the dough into a dough ball tray rounder.

6. The method of claim 5, further comprising placing the dough balls into the proofer for 45 minutes prior to frying the dough balls.

7. The method of claim 6, wherein the step of frying comprises frying the dough balls for 3 and half minutes.

8. The method of claim 1, wherein the filling is custard.

9. The method of claim 1, wherein the filling is fruit based.

10. The method of claim 1, wherein the plurality of components comprises 9,944 grams of bread flour, 889 grams of milk powder, 785 grams of cane sugar, 680 grams of whole egg powder, 523 of butter powder, 235 of dough improver, 209 of egg yolk powder, 52 grams of nutmeg powder, 52 grams of lemon peel powder, 52 grams of vanilla extract powder, and 26 grams of salt.

11. The method of claim 1, wherein at least 7 liters of water is added to the mixture.

12. The method of claim 1, wherein 53 grams of canola oil are added to the dough during a kneading and folding process.

13. A fried dough ball made in accordance with the method of claim 1.

14. A method for making malasadas comprising:
mixing a plurality of components to form a mixture, the mixture comprising; bread flour, whole milk powder, cane sugar, whole egg powder, butter powder, dough improver, egg yolk powder, nutmeg powder, lemon peel powder, vanilla extract powder, and salt;
placing the mixture into a container with a packet of instant yeast;
placing the mixture into a mixer with the instant yeast and mixing the mixture and the instant yeast;
adding water to the mixture and instant yeast to form dough;
creating dough balls with the dough;
frying the dough balls;
coating the fried dough balls with sugar; and
filling the fried dough ball with a filling.

15. The method of claim 14, wherein the step of coating further comprises coating the fried dough ball with cinnamon.

16. The method of claim 14, wherein the mixture weighs greater than 17 kilograms.

17. The method of claim 14, further comprising placing the dough into dough tubs and then into a proofer for an hour prior to creating the dough balls.

18. The method of claim 14, wherein the filling is custard.

19. The method of claim 14, wherein the plurality of components comprises 9,994 grams of bread flour, 889 grams of whole milk powder, 785 grams of cane sugar, 523 grams of butter powder, 235 grams of dough improver, 52 grams of nutmeg powder, 52 grams of lemon peel powder, 52 grams of vanilla extract powder, and 26 grams of salt.

20. The method of claim 14, wherein at least 7 liters of water is added to the mixture.
